(19) United States
(12) Patent Application Publication
(10) Pub. No.: US 2010/0050823 A1
(43) Pub. Date: Mar. 4, 2010

(54) Tree step tool with custom magnet

(76) Inventor: Wayne Christopher Blankenship, Sullivan, MO (US)

Correspondence Address: WAYNE C. BLANKENSHIP, 836 COPPER HOLLOW, Sullivan, MO, 63080, US

(21) Appl. No.: 12/584,184

(22) Filed: Sep. 1, 2009

Related U.S. Application Data
(60) Provisional application No. 61/190,606, filed on Sep. 2, 2008.

(51) Int. Cl. B25B 13/50; B25B 23/12; A01M 31/00

(52) U.S. Cl. 81/125

(57) ABSTRACT

In accordance with the present invention, a tool for starting, installing, and removing rod-type steps includes a handle (B), head (C), and a loading slot (A) also includes a custom magnet (15) seated in bottom. The magnet (15) ensures engagement of rod-type steps before operation.

### CROSS-REFERENCE TO RELATED APPLICATIONS

This application claims the benefit of Provisional Patent Application Ser. No. 61/190,606, filed 2008 Sep. 2 by the present inventor.

### FEDERALLY SPONSORED RESEARCH

Not Applicable

### SEQUENCE LISTING OR PROGRAM

Not Applicable

### BACKGROUND

1. Field

This application relates to Tree Step Tools, specifically to such tools used on rod-type steps (hunting accessories) to start, install, and remove them.

2. Prior Art

In the hunting industry standard rod-type steps are used for getting to fixed, portable tree stands. Originally these steps were installed by hand. However, most hunters abandoned using these steps due to the complications with starting and installing these steps in the tougher hardwood trees.

Thereafter, several types of Tree Step Tools were designed to start, install, and remove these rod-type steps. U.S. Pat. No. 7,231,853 to Burdge (2007), discloses a leverage tool with incorporated hammer head for starting the steps; however, the need for a two-hand operation causes a safety concern to most when suspended up to 20+ feet in a tree. Several other tools have also been proposed including U.S. Pat. No. 7,017,449 to Ritchings (2006), U.S. Pat. No. 7,258,045 to Smith (2007), and U.S. Pat. No. 5,624,007 to Mahaffy (1997), disclosing mere leverage tools with handles. These tools all required starting the steps by hand before the tools can be used for completing the installation.

### SUMMARY

In accordance with one embodiment a Tree Step Tool with Custom Magnet comprises a Solid Steel round body having a loading slot, custom magnet press fit in position, handle, and head.

Accordingly, several advantages are to provide an improved tree step tool, to provide means of starting, installing, and removing rod-type steps with one-handed operation.

### DRAWINGS

### Figures

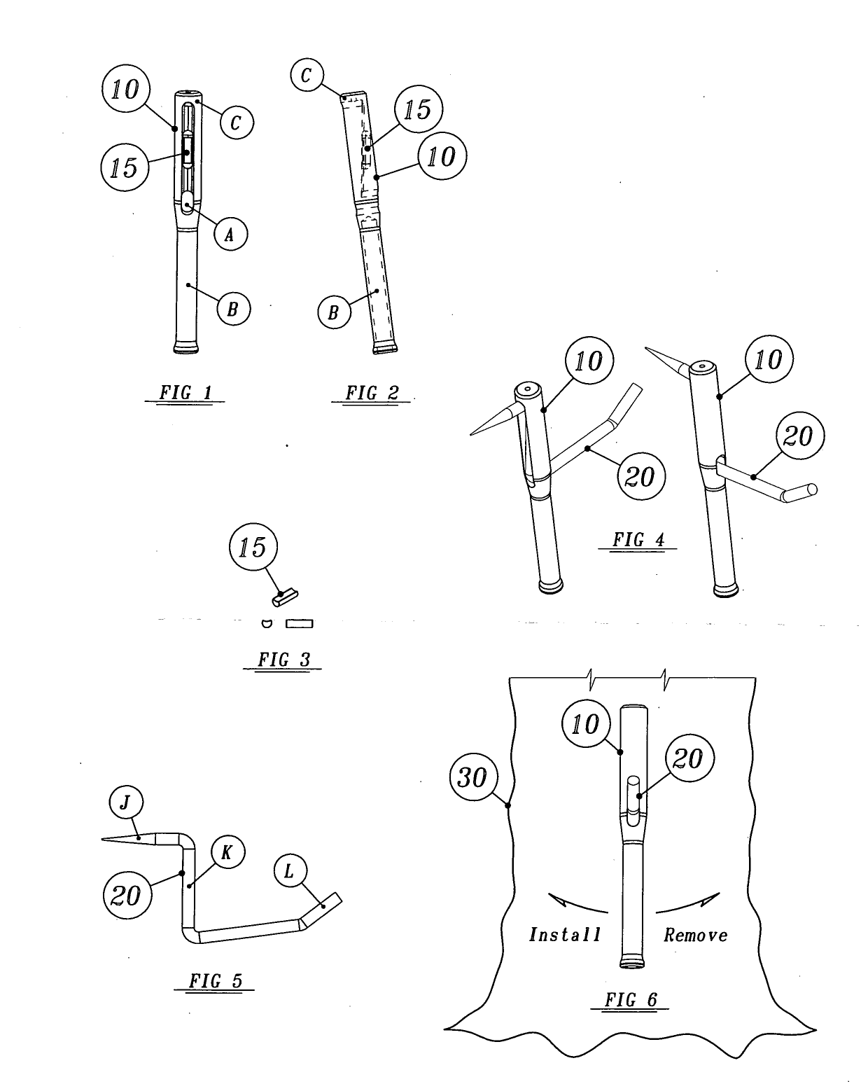

FIG. 1 is a perspective view taken from the loading side of the tool.

FIG. 2 is a perspective view taken from the right side of the tool.

FIG. 3 is (3) views of the Custom Magnet.

FIG. 4 is (2) isometric assembly views showing a standard rod-type step installed into the tool and ready for use.

FIG. 5 is a side view of a typical rod-type step.

FIG. 6 is a perspective view taken from step on exit side of the tool with a tree in the background showing rotational direction of use for installing and removing step.

### DRAWINGS

### Reference Numerals

10 Tool
A Loading Slot
B Handle
C Head
15 Magnet
20 Step
J Screw Section
K Center Section
L Step Section
30 Tree

### DETAILED DESCRIPTIONS

### FIGS. 1, 2, 3, 4, 5, 6

FIG. 1 is a perspective view taken from the loading side of the tool 10 constructed in accordance with the invention. The tool 10 is made of mild steel machined as shown. The magnet 15 is a custom nickel-plated magnet press fit into tool 10 as shown. Other features include the loading slot A, the handle B, and the head C.

FIG. 2 is a perspective view taken from the right side of the tool 10, showing the loading slot A, magnet 15 in position, handle B, and head C.

FIG. 3 is (3) views of the custom magnet 15

FIG. 4 is (2) isometric assembly views showing a standard rod-type step 20 installed into the tool 10 and ready for use.

FIG. 5 is a side view of a typical rod-type step 20 with screw section J, center section K, and step section L.

FIG. 6 is a perspective view taken from step 20 exit side of the tool 10 with a tree 30 in the background showing rotational direction of use installing and removing step 20.

### Operation: FIGS. 1, 2, 3, 4, 5, 6

In operation, one grips the handle B of tool 10 with the loading side of the tool 10 (FIG. 1) facing the opposite hand and the head C facing upward. With the opposite hand, grasp center section K of step 20 (FIG. 4) in a vertical position with screw section J facing upward and away from tool 10 and step section L facing loading slot A of tool 10. Insert step section L of step 20 thru loading slot A of tool 10 until center section K of step 20 is attached and seated onto magnet 15. At this time, swing tool 10 by the handle B in a hammer-like fashion toward the intended area of the tree striking the screw section J of the step 20 at right angle to the tree. Once embedded in the tree, rotate handle B of tool 10 parallel to tree in clockwise motion until desired depth is achieved. Rotate handle B until pointed towards ground. Grasp tool 10 at head C and pull away from tree to break contact with magnet 15 and slide off of step 20. This completes installation. To remove step 20—slide tool 10 over step section L of step 20 until magnet 15 is attracted and seated onto the center section K of the step 20. Once seated, grasp handle B of tool 10 and rotate counter-clockwise and parallel to tree until screw section J of step 20 is free from tree. Grasp screw section J of step 20 and pull away from tool 10 until the contact is broken from magnet 15, once broken, slide step 20 away from tool 10 until the step section L is removed from loading slot A. This completes the installation and removal of a standard rod-type step 20.

### Advantages

From the description above, a number of advantages of my tree step tool with custom magnet become evident:

(a) The use of the custom magnet permits starting, installing, and removing rod-type steps with one-handed operation.

I claim:

1. In a Tree Step Tool with Custom Magnet of the type comprising a cylindrical body of material having a loading slot and through hole, the improvement wherein said Tree Step Tool has a Custom Magnet seated in the loading slot for holding rod-type steps during starting, installing, and removal
